(19) United States
(12) Patent Application Publication
(10) Pub. No.: US 2021/0213580 A1
(43) Pub. Date: Jul. 15, 2021

(54) MILLING MACHINE

(71) Applicant: Ivoclar Vivadent AG, Schaan (LI)

(72) Inventors: Senad Lidan, Zurich (CH); Vadim Bogdan, Pforzheim (DE); Gottfried Rohner, Altstatten (CH)

(21) Appl. No.: 17/147,665

(22) Filed: Jan. 13, 2021

(30) Foreign Application Priority Data
Jan. 13, 2020 (EP) 20151367.8

(51) Int. Cl. B23Q 15/013; B23Q 5/32

(52) U.S. Cl. CPC B23Q 15/013; B23Q 5/32

(57) ABSTRACT

The invention relates to a milling machine (10), having a milling spindle (12) and a workpiece holder (24) which is mounted so as to move with respect to the milling spindle (12) in at least 3 or 4 spatial directions, having a workpiece which is held in a clamped manner on the workpiece holder (24), having a sensor, relative to which the workpiece can be brought into contact and relative to which workpiece the sensor can be moved to sense the workpiece, wherein the sensor is designed as a sensing probe (18), having a deflection and detection of a deflection of its sensing element (30) in at least 1 spatial direction, or in 2 or 3 spatial directions.

### CROSS-REFERENCE TO RELATED APPLICATIONS

This application claims priority to European patent application No. 20151367.8 filed on Jan. 13, 2020, the disclosure of which is incorporated herein by reference in its entirety.

### TECHNICAL FIELD

The invention relates to a milling machine, a combination of a milling machine and at least one workpiece, and a milling method.

### BACKGROUND

It is known that milling machines which comprise a tool spindle and a workpiece holder can be fitted out so that a check is made as to whether or not the workpiece is ready for machining. In this way, it should be ensured that the milling machine does not mill into empty space such as when a robot arm, tool carriage and/or workpiece holder which should grip a workpiece, misses it. Otherwise, this would result in unproductive empty running of the milling machine.

Furthermore, it is known from CH 663 891 A1 and corresponding U.S. Pat. No. 4,766,704, which is hereby incorporated by reference, to carry out an optical scan of the machined surface shape in the case of a dental milling machine which produces a dental restoration part from a blank.

Finally, it is known from DE 40 30 175 A1 to adjust a tool drive motor to a starting rotational speed in order to calibrate the workpiece and tool, this speed being so low that upon contact between the workpiece and tool the rotational speed becomes 0.

In this way, upon contact between the workpiece and tool, the drive motor is practically fully stopped, whereby the position of the surface of the tool relative to the workpiece is detected.

However, the detection devices known thus far for the relative position between the workpiece and tool are comparatively imprecise.

### SUMMARY

Thus, it is the object of the invention to create a milling machine, a combination of a milling machine and a workpiece, and a method for operating a milling machine according to the claims, which can be used universally and permit improved precision and improved reproducibility of the results of the milling.

In accordance with the invention, this object is achieved by the independent claims. Advantageous developments are apparent from the dependent claims.

In accordance with the invention, the sensor is designed as a sensing probe, it is thus neither an optical scanner nor a braking element as is the case in the above-mentioned prior art. One example of a probe system is set forth in U.S. Pat. No. 9,065,492, which is hereby incorporated by reference in its entirety.

In accordance with the invention, this sensing probe comprises a sensing element which can be deflected. In this case “deflect” should include both a detectable movement in both transverse directions (X and Y) and also in the longitudinal direction of the sensing probe (Z direction).

By means of the deflection, the proximity between a surface of the workpiece and the sensing probe is detected. As soon as the deflection exceeds a preset threshold value, the sensing element outputs a signal to an evaluation device, which displays that the proximity to be detected has been reached.

Provision is made in accordance with the invention that the sensor element can be deflected in 1 or several spatial directions. This means that the detection of proximity is possible in 2 or more directions.

Therefore, the prerequisites are met for detecting the proximity in 2 spatial directions without rotation of the workpiece relative to the tool and/or the sensing probe.

The two spatial directions can extend e.g. orthogonally to each other. By sensing different points on the mutually orthogonal surfaces, it is also possible to establish whether the surfaces concerned are actually orientated orthogonally to each other on the workpiece.

The at least 2 spatial directions preferably extend orthogonally to each other. This simplifies the calculation of the detected and current relative positions of the sensing probe and workpiece.

In addition, it makes it possible in a simpler manner to indicate an offset between a system zero point and this position. An example of this would be the faulty clamping of a workpiece in the workpiece holder. This would lead to an offset which a device for evaluation of the output signal of the sensing probe would immediately recognise.

An offset would also arise if the workpiece holder was dirty, or if the user performs the clamping incorrectly. The device for evaluation of the output signal of the sensing probe would also immediately recognise that an error is present in this case.

The detection preferably takes place not in 2 but in 3 spatial directions in the Cartesian coordinate system. However, it is also possible e.g. to use any other coordinate system.

In an advantageous embodiment of the invention, the sensing probe is inserted into the milling spindle instead of a tool which is inserted therein during operation, and is held therein in a clamped manner. It is particularly favourable if the sensing probe has a stop relative to the milling spindle and so the sensing probe is in a defined position in the milling spindle.

The stop can also be produced by any mutually facing surfaces of the milling spindle and sensing probe, e.g. in each case surfaces with a surface normal, which extend parallel to the axis of the milling spindle.

The sensing probe preferably has circular symmetry and is clamped in on the axis of the milling spindle.

In an advantageous embodiment of the invention, provision is made that the milling machine has a stationary spindle motor and a stationary spindle housing, in which the milling spindle is rotatably mounted.

In an advantageous embodiment of the invention, provision is made that a spindle motor has been switched off or is switched off, in particular automatically switched off, when the sensing probe is being clamped into the milling spindle.

A workpiece can be mounted in a clamped manner on a workpiece holder and can move in 3, but preferably in 5, spatial directions. The movement can be produced preferably by means of a rotor arm, a gripping device and/or a tool carriage.

In an advantageous embodiment of the invention, provision is made that the milling machine comprises a control device with which, when the sensing probe is clamped in the milling spindle, the relative movement of the sensing probe and workpiece can be controlled, and the workpiece can be brought into contact with the sensing probe. One example of a control system is set forth in U.S. Ser. No. 10/596,677, which is hereby incorporated by reference in its entirety.

In an advantageous embodiment of the invention, provision is made that the sensing probe detects the orientation and spatial position of a workpiece, in which sensing is carried out at, at least, 2 mutually spaced-apart points of the workpiece, preferably at, at least, 3 points.

Furthermore, it is possible to provide the sensing probe in a fixedly mounted tool magazine in the milling space or in a tool magazine which can travel. At that location, the sensing probe is then preferably received at a preset position.

For use in the tool spindle, a robot arm then grips the sensing probe and plugs it into the tool spindle when the chuck is open.

It will be understood that in the case of this solution, it is also necessary to provide for the transmission of measuring signals of the sensing probe to the evaluation device.

With this solution, the transmission is preferably to be provided wirelessly, e.g. by radio or infrared. A wireless communications unit can be housed for this purpose in the shaft of the sensing probe.

In an advantageous embodiment, the robot arm has gripping arms which can also serve for changing the tool. When such gripping arms or any other gripping handle is/are provided, the sensing probe can then also be inserted into the milling spindle preferably using such means.

It will be understood that the spindle motor is switched off before the sensing probe is inserted into the milling spindle.

A particular advantage of the invention is found in the precision of the detection of the relative position of the workpiece and milling spindle.

The sensing probe can operate very precisely, e.g. with a basic precision of 0.005 mm.

The sensing reproducibility can be even better, e.g. 0.002 mm.

The sensing element can terminate in a sensing ball and consist of a material with a particularly low thermal expansion coefficient. Alternatively, the temperature of the sensing element is detected via a temperature sensor and fed to an evaluation device and then the change in length of the sensing element is calculated into the evaluation on the basis of the current temperature. The evaluation device may be a part or section of the control device of the whole machine which is implemented as a software in a main processor. Aa software routine (algorithm) detects the movement axis of the stylus and the (top end) ball: output (touch probe) signal change->detection (e.g. comparison with a threshold) outputting a detection result.

For transmission of the deflection of the sensing element, this element can be mounted in the sensing probe housing preferably multi-axially. Pressure sensors are then preferably provided in the housing and are distributed multi-axially and respond to the deflection of the sensing element.

In an advantageous embodiment of the invention, the sensing element terminates in or at a ball. The diameter of the ball may have a range of 0.1 to 1.2 mm, with examples of diameter of 0.5 mm or 0.8 mm or 1 mm. Circle-symmetrical contact is provided owing to the ball shape. This is beneficial when different mutually orthogonal surfaces are to be travelled along for sensing, since then the same distance is present between the axis of the sensing element and the contact region in the case of lateral contact irrespective of the orientation, i.e. irrespective of which region of the ball comes into contact.

Provision is made in accordance with the invention that the evaluation device detects at least the minimum initial deflection of the sensing element during contact. For example, a movement of 0.008 mm with respect to the axis of the sensing element can be detected and sensed by the evaluation device.

This then applies both during lateral deflection and also during deflection in the direction of the end face of the sensing element.

It is also possible to use a sensing probe in which, beyond the initial deflection of the sensing element, the degree of deflection can be detected over a considerable angular range, e.g. a 3 or even 5 mm deflection path.

Such sensing probes also make it possible to check the movement path of the robot arm which holds the workpiece. Instead of this, a workpiece carriage or other workpiece holder which is to grip a workpiece can be used.

In an advantageous embodiment, provision is made that the workpiece is formed as a blank of a dental ceramic. Such blanks are produced e.g. from lithium disilicate and pre-sintered to form lithium metasilicate. They are adhered to a blank holder and as a blank are intended to be milled by the dental milling machine to form a dental restoration part. Furthermore, there are also metal blanks e.g. titanium blanks which are formed, in particular, as one piece.

The invention can also be applied to such blanks.

In both embodiments, during clamping of the workpieces into the workpiece chuck, it is possible for dirt to enter between the clamping space, i.e. the space surrounding the workpiece chuck, and the blank holder or the blank. This can lead to undesirable shifting of the orientation of a blank, i.e. to an offset in one of the spatial directions X, Y and Z, or possibly to inadvertent rotation of the blank.

This applies in a similar manner during manual fitting by the user.

The orientation of the blank in the workpiece holder is important in order to be able to make the dental restoration at the correct point. In a preferred manner, at least one and particularly preferably at least 2 mutually orthogonal and mutually adjacent surfaces of the blank are then ground flat or milled flat in advance.

This slight convexity, as caused during pre-sintering, is thereby eliminated. By pre-milling, the orthogonality of the surfaces can be fundamentally ensured when the milling machine is correctly controlled.

This also applies when the pre-milling takes place in a dedicated upstream method, i.e. before the actual production.

In an advantageous embodiment in accordance with the invention, each surface is detected at 3 contact points in space. The position of the planar surface of the evaluation device is thus known. It will be understood that in the individual case even just 1 contact point or possibly 2 contact points will suffice in order to detect the position of the surface, e.g. if the orientation thereof is already known in advance by some other means.

If 2 corresponding surfaces, which should be orthogonal to each other, are now detected in the same way by means of three-point detection, the orthogonality can also be checked at the same time if this is desired.

In this way, the particular advantage arises that the sensing probe in accordance with the invention operates multi-dimensionally, i.e., it detects e.g. the deflection of the sensing element on the end face and detects a lateral deflection of the sensing element.

Then, by travelling in space, the desired detection of both surfaces can be ensured with the sensing probe in the same position. It is particularly favourable that in so doing, the workpiece does not have to be rotated and so the imprecisions and changes of angle associated therewith do not have to be taken into consideration.

In a further embodiment of the invention, provision is made for the use of a 6-fold tool holder for clamping and holding 6 blanks. Such a holder can also be partially fitted, i.e. fitted in such a way that e.g. blanks are held in a clamped manner only in positions 1, 4 and 5.

In an advantageous embodiment of the invention, the presence of the blanks at positions 1, 2, 3, 4, 5 and 6 can first be checked. By means of the evaluation device, it can be established that blanks are present only at positions 1, 2, 3 and 5.

This presence test can e.g. be carried out in that the workpiece holder is moved with respect to the sensing probe in such a way that this sensor would output a signal when a blank is present and does not output a signal when one is not present.

The mutually orthogonal and flat-ground surfaces of the blanks at positions 1, 4 and 5 are then preferably detected blank after blank and in particular in that at least 3 measurement points per blank are selected e.g. one at the end or lateral surface and 2 at the surface facing the sensing probe.

It is also possible to select the number of measurement points in any other way in order to improve the precision and detectability of the position of the blank in space.

The detected position of the blank is then stored in the evaluation device as fundamentally located in relation to a zero point or a zero axis of the milling coordinate system.

As soon as the measurement is concluded, the sensing probe is removed, e.g. via the robot arm, a workpiece carriage or in any other way including e.g. manually, from the milling spindle and a tool is introduced which has likewise been measured in advance.

The evaluation device has then calculated the relative offset between the current position of the relevant blank and the zero point or the zero axis of the milling coordinate system and superimposes this offset on the numerically controlled (NC) data which the milling machine has received for the milling step.

In a modified embodiment, the blanks have central apertures which can also be referred to as holes. The term “hole” and therefore the term “aperture” is to be understood in this case not to be limited to round holes or other holes which are of a fixed shape. It is rather the case that in this embodiment of the invention, polygonal, conical or other holes can be used, i.e. any with a shape deviating from the cylindrical shape.

In this respect, such a hole can also be referred to as an “aperture” or “depression”.

Such blanks can be used e.g. for abutments or else for supra-constructions with a screw channel, i.e. ones in which access to the implant screw is possible via this channel, and in which the channel is filled during finishing of the dental restoration in the patient's mouth.

The position of this aperture in space is important especially in abutments, and provision is made in accordance with the invention that the sensing element can pass or enter, at least with its front sensing ball, into the aperture and detect the position thereof. For this purpose, the sensing ball has a smaller diameter than the aperture. However, it is also possible for the sensing ball to have a larger diameter than the aperture. In any case, it is then suitable for the detection of the position of a surface. Furthermore, it is possible to detect the boundary edge of the surface, i.e. the edge at which the surface abruptly terminates.

In this way, the position of the surface adjoining at that point can also be detected at the same time, at least when the two surfaces are orthogonal to each other.

The boundary edge can also be detected by the sensing element when the sensing ball thereof has a larger diameter than the aperture.

In accordance with the invention, the deflection force of the sensing element is quite small, e.g. 200 to 500 mN. The sensing element comprises a sensing ball of a hard material which in this respect is wear-resistant. It can thus preferably also be guided along the blank so that it is also possible to detect whether a surface of the blank is also actually planar over its extension.

Touch probes may operate with an optical switch as their sensor. A lens system collimates the light emitted by an LED and focuses it onto a differential photocell. Upon deflection of the stylus, the differential photocell produces a trigger signal. The stylus of the TS is rigidly connected to a plate that is integrated in the probe housing on a three-point bearing. This three-point bearing ensures the physically ideal rest position. Thanks to the non-contacting optical switch, the sensor is free of wear.

Alternatively touch probes may use a high-precision pressure sensor. The trigger pulse is obtained through force analysis. The forces that arise during probing are processed electronically. This method delivers extremely homogeneous probe accuracy over 360°. The deflection of the stylus is measured by multiple pressure sensors arranged between the contact plate and the probe housing. During probing of a workpiece, the stylus is deflected and a force acts on the sensors. The resulting signals are processed, and the trigger signal is generated. The relatively low probing forces involved provide high probe accuracy and repeatability, virtually without the characteristics of tactile probing.

Further advantages, details and features will be apparent from the following description using a plurality of exemplified embodiments of the invention with reference to the drawing.

U.S. 20110104642, U.S. Pat. Nos. 10,876,861, 10,871,763, 10,823,550, 10,788,807, 9,454,145, 5,319,424, 20210003393, 20210003379, 20200363193, 20200397440, 20200348123, 20200356210, 20180321061, 20180220533, 20110094117, 20120297906, 20120242326, 20090126214, 20070006473, 20050168213, and 20050072015, directed to machine tool technology and/or sensing technology, are incorporated herein by reference in their entirety.

### BRIEF DESCRIPTION OF THE DRAWINGS

In the drawings:

FIG. 1 is a schematic view of the part of a milling machine in accordance with the invention relevant to the invention, the milling machine having a sensor inserted into the milling spindle;

FIG. 2 shows a multiple workpiece holder for a milling machine in accordance with the invention;

FIG. 3 shows an enlarged perspective view of a part of a combination in accordance with the invention of a milling machine and a workpiece, showing the sensing probe;

FIG. 4 shows a view of contact positions of the sensing probe on a workpiece in a further embodiment;

FIG. 5 shows a view of contact positions in another embodiment of the invention;

FIG. 6 shows a perspective view of another workpiece; and

FIGS. 7A, 7B and 7C show a perspective view of a further embodiment of a milling machine with a multiple workpiece holder.

### DETAILED DESCRIPTION

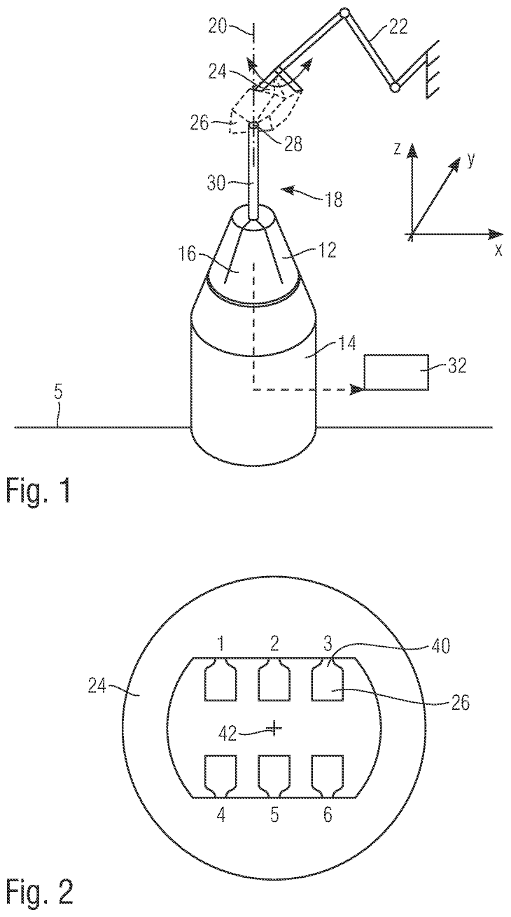

FIG. 1 illustrates a schematic perspective view of a first embodiment of a milling machine 10 in accordance with the invention.

A milling spindle 12 belongs to the milling machine 10. The milling spindle 12 has a vertical axis and is mounted and guided in a spindle housing 14. The milling spindle 12 extends upwards and the spindle housing 14 is fixedly connected to a frame 5 of the milling machine 10 and is thus stationary. It will be understood that a horizontal orientation of the milling spindle is also possible instead of this.

In accordance with the invention, the milling machine 10 can be designed in any manner with respect to its axial distribution. A 5-axis machine is preferably used, i.e. a machine in which the sum of the movement axes of the workpiece and tool is 5. This thus includes machines with the axis distributions of 5/0, 4/1, 3/2, 2/3, 1/4 and 0/5.

However, e.g. 4-axis or 6-axis machines are also possible without departing from the scope of the invention.

A tool can be clamped into the milling spindle 12, in a manner which is known per se, by means of a chuck.

In accordance with the invention, instead of the tool, a sensing probe 18 as a sensor is clamped in at the point at which the tool is clamped in during operation. An example of an available sensing probe is a Touch Probe by Heidenhain, Schaumburg, Ill.

For this purpose, the chuck 16 is opened wide enough for the shaft of the sensing probe 18 to fit inside and for the sensing probe 18 to be introduced as far as the stop. The chuck 16 is then closed.

The sensing probe 18 extends precisely on the axis of the milling spindle 16 of the milling machine 10. The milling machine 10 further comprises a schematically illustrated robot arm 22 or a workpiece carriage. At its front end, this supports a workpiece holder 24, also illustrated schematically. The workpiece holder 24 can be opened and closed in a motorised manner in order to receive a workpiece 26, also illustrated schematically.

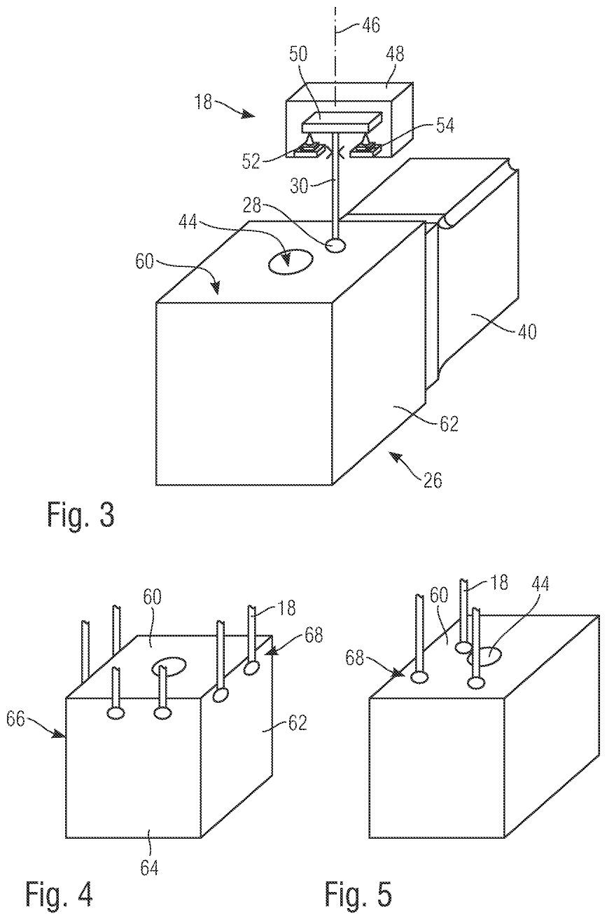

The workpiece 26 can be moved in 5 spatial directions by means of the robot arm 22. The precise design of the workpiece 26 in the present exemplified embodiment can be seen better in FIG. 3.

FIG. 1 shows that the workpiece 26 can be guided with one lateral surface onto the sensing probe 18. The robot arm 22 moves until the relevant lateral surface of the workpiece 26 lies against the sensing probe and presses very gently against it.

In the illustrated exemplified embodiment, this is an axial pressure, i.e. in the direction of the axis 20. In order to sense pressure, the sensing probe 18 comprises a sensing ball or sphere 28 which, at the front end, which terminates at sensing element 30, such as a cylindrical stylus, of the sensing probe 18.

Incidentally, the sensing element 30 is movably guided in the sensing probe 18, which sensing probe 18 is clamped in the milling spindle 12 and the part thereof which is relevant in this respect is not visible.

The sensing element 30 may be movably guided in the direction of the axis 20 but also laterally, i.e. in the two directions orthogonal thereto.

The sensing probe 18 in accordance with the invention is a three-dimensional sensing probe 18.

The sensing probe 18 outputs a signal as soon as a deflection in one of the spatial directions is detected, i.e. axially parallel (Z direction) or laterally with respect thereto (X direction and Y direction). The signal is produced even when a very slight deflection by e.g. 0.01 mm is present.

Different signals are preferably output depending on the spatial direction in which the movement takes place.

The output signals of the sensing probe 18 are fed to an evaluation device 32 of the control device or processor. Incidentally, the evaluation device 32 detects the first output of a signal with respect to the movement of the sensing element 30 in relation to the sensing probe 18, but naturally also any further movements.

In the illustrated exemplified embodiment, based on the detection of the deflection by the evaluation device 32, the vertical movement of the robot arm 22 is stopped and the position of the robot arm 22 thus attained is stored. This is, so to speak, a calibration position or zero position in the direction of the axis 20.

It will be understood that a corresponding drive for the robot arm 22 is provided, which is connected to the evaluation device 32. This drive is not shown in the figures and is designed in a manner known per se.

Leaving aside the movements of the workpiece holder 24 and therefore of the workpiece 26 in the three Cartesian coordinate axes, the robot arm 22 permits a rotation of the workpiece holder 24 about 2 mutually orthogonal axes.

Therefore, in the case of a cuboidal blank it is possible to approach and to sense at least 5 or 6 cuboid surfaces in that they are brought into contact with the sensing ball 28.

The 6th surface of the cuboidal blank is conventionally occupied at least in the middle by a workpiece holding pin 40, not illustrated. When the relevant surface is accessible laterally of the holding pin 40, the detection of the position of the 6th surface of the blank is also possible.

For each of said surfaces, but at least for 2 mutually orthogonal surfaces, the position of the blank at this surface is detected by the sensing probe 18 in accordance with the invention and stored.

FIG. 2 shows an embodiment of a workpiece holder 24 modified with respect to the preceding one. This workpiece holder 24 comprises 6 receiving positions 1, 2, 3, 4, 5 and 6.

Provision is made that the workpieces are formed as blocks, in particular of ceramic, and a plurality of blocks are held in a clamped manner in the workpiece holder 24.

At these receiving positions, clamping apertures for workpiece holding pins 40 are provided, and in the illustrated exemplified embodiment, in the simplified illustration according to FIG. 2, all 6 receiving positions are fitted with workpieces 26. In this case, each workpiece 26 comprises a workpiece holding pin 40 to which the ceramic body of the workpiece 26 is adhered, and the holding pin 40 is clamped at the relevant receiving position. It will be understood that the ceramic body and the holding pin can also be formed as one piece.

The workpiece holder 24 according to FIG. 2 can be received in a modified robot arm 22, at the movement end thereof, and can travel therein in any spatial directions.

The dimensioning of the sensing probe 18 compared with the workpieces 26 according to FIG. 2 and the workpiece holder 24 is selected in such a way that the sensing probe 18 can also be introduced in any manner into the intermediate spaces between the workpieces 26 and can carry out detection steps at those locations.

It is beneficial if the milling machine 10 comprises a workpiece holder 24 which can be fitted with a plurality of workpieces, and the sensing probe 18 detects not just the position of the workpiece but also its presence, in particular by means of an evaluation device 32.

In turn, in the case of each ceramic body of the workpiece 26 which is to be milled, 2 surfaces are preferably ground flat in advance. These are used for the calibration of the position of the relevant workpiece 26 in space.

In addition, a zero point 42 of the workpiece holder 24 exists, wherein in accordance with the invention it is possible additionally to detect the spatial position of each workpiece 26 with respect to the zero point 42.

FIG. 3 shows in detail a modified embodiment of a milling machine 10 in accordance with the invention. In this case, as also in the remaining figures, like reference numerals denote like or corresponding parts.

The workpiece 26 with the holding pin 40 is clearly shown larger than in the previous figures. The workpiece 26 also comprises an aperture or opening 44, in particular a through-aperture 44 or any other aperture.

This aperture extends orthogonally to the basically cuboidal workpiece 26 through 2 side surfaces. The diameter of the aperture 44 is clearly larger than the diameter of the sensing probe 18 and of the sensing ball 28 of the sensing probe 18. Alternatively, however, the diameter of the sensing probe (18) and of the sensing ball (28) can also be larger, wherein a smaller deflection triggers a signal.

The sensing probe 18 comprises the sensing element 30. The sensing element 30 is mounted on a housing 48 of the sensing element 30 via a multi-axis movement by a multi-axis bearing 46. The deflection force, i.e. the force required for the deflection of the sensing element 30 of the sensing probe 18 is 1 N or less.

The sensing element 30 terminates at a deflection plate 50 disposed beyond or on the far side of the multi-axis bearing 46. The deflection plate 50 is designed in such a way that it lies against a plurality of pressure sensors, of which two pressure sensors 52 and 54 are illustrated in FIG. 3.

Upon deflection of the sensing element 30 on the sensing ball 28 at least one of the pressure sensors, e.g. pressure sensor 54, is now compressed and therefore activated.

With the initial deflection, an initial deflection signal is output which is fed to the evaluation device 32.

Even if the pressure sensors 52 and 54 are illustrated as switches, it will be understood that e.g. strain gauges can be used instead of these, which measure and detect the size of the deflection.

Incidentally, this embodiment can be beneficial if it is desired to detect the movement of the workpiece 26 relative to the milling machine 10.

When the sensing ball 28 of the sensing probe 18 is introduced into the aperture 44 it does not undergo any deflection initially. However, when the sensing probe 18 is then moved laterally, the sensing ball 28 lies against the internal diameter on the inside of the aperture 44 and undergoes a deflection which activates one of the pressure sensors 52 and 54.

By this means, the position of the aperture 44 can also be determined via the lateral deflection.

The aperture 44 is provided in a surface 60 of the workpiece 26. This surface 60 is ground or milled flat in advance, as is a surface 62 orthogonal thereto.

These two said surfaces 60 and 62 are preferably approached multiple times, and by the deflection of the sensing element 30 the position of the surface in space is detected in each case.

The detection of the position of the surface 62 in space, but also of the further surfaces 64 and 66, by means of a plurality of sensing positions 68 is illustrated schematically in FIG. 4.

The surfaces 62, 64 and 66 are each approached at two mutually spaced-apart points. The orthogonality of the orientation of the surfaces 62 to 66 with respect to each other can thereby be detected.

FIG. 5 illustrates 3 sensing positions 68 of the surface 60. These 3 sensing positions 68 permit the evaluation device 32 to detect and store the exact position of the surface 60 in space.

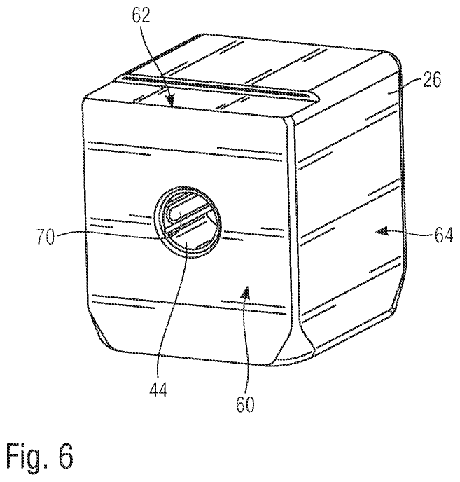

FIG. 6 shows a perspective view of another workpiece 26. The workpiece 26 comprises an aperture 44, specifically a through-aperture. A rotation-prevention element 70 is provided therein. Examples include a protrusion or bump on the inside of the workpiece for preventing movement of the holder inserted into aperture 44.

The position of the rotation-prevention element 70 can be detected in accordance with the invention by means of the sensing probe 18 by contact at that location and by deflection of the sensing element 30.

Therefore, the determination of the correct orientation of the blank 26 in space is possible. An aperture 44 of this type can serve e.g. as an implant screw channel. The rotation-prevention means 70 extends outwards, i.e. as a depression, in the exemplified embodiment. Alternatively, it can also point inwards, i.e. protrude radially inwards.

In addition, the position of the relevant surfaces 60, 62 and 64 can also be determined, as described with reference to FIG. 4. These surfaces are e.g. orthogonal to each other. A respective boundary edge extends between them, wherein the boundary edges are partially machined, i.e. milled in a notched manner, and partially non-machined. Between the surfaces 60 and 64 a non-machined boundary edge 71 extends, and a machined boundary edge 72 extends opposite thereto on the surface 60, as illustrated in FIG. 6.

The position of the boundary edges is likewise detectable in accordance with the invention if required. For example, the sensing ball 28 can slide along the surface 60. As soon as the boundary edge 72 is reached, the sensing element 30 is deflected, and the position of the boundary edge is thereby detected.

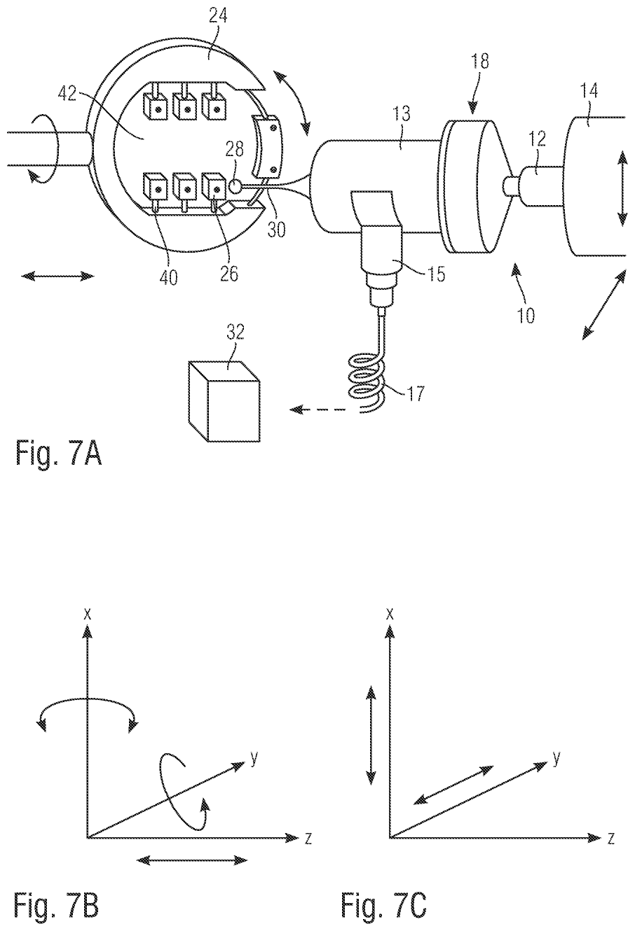

FIGS. 7A, 7B and 7C show a schematic, perspective view of further embodiment of a milling machine 10 in accordance with the invention.

Instead of the tool, a sensing probe 18 as a sensor is clamped in at the point at which the tool is clamped in during operation. As also in other embodiments, in this case, the sensing probe 18 is clamped into the milling spindle 12 via a chuck not illustrated in the figure. In this embodiment, the milling spindle 12 extends horizontally, and the spindle housing 14 is movably connected to a frame of the milling machine 10. The spindle housing 14 is movable in two directions, specifically horizontally on the y-axis of the illustrated coordinate system, and vertically in the direction of the x-axis. This would correspond, in the illustration, to a displacement along the x-axis and y-axis, i.e. in both transverse directions of the sensing element 30.

In this exemplified embodiment, the sensing probe 18 comprises a functional body 13, a connection socket or bushing 15, a connection cable 17, a sensing element 30 and a sensing ball 28. The functional body 13 comprises the electronics of the sensing probe 18. The connection socket 15 permits the connection to the evaluation device 32 via the connection cable 17 in order to transmit the output signals generated by the deflection of the sensing element 30 to the evaluation device 32.

Electronics may include interface electronics for integration for adaption of the touch probe signals to a CNC control. Examples include an optocoupler relay.

Furthermore, FIGS. 7A, 7B and 7C show an embodiment of a workpiece holder 24 modified with respect to the exemplified embodiment of FIG. 1. This is horizontally movable in the z-direction, specifically in the axial direction of the sensing probe 18 and is pivotable about two fastening axes, specifically in the plane of the workpiece holder 24. With respect to the illustrated coordinate system, these movements correspond to rotation about the y-axis, pivoting along the x-axis and movement along the z-axis. The workpiece holder 24 comprises receiving positions with clamping apertures for workpiece holding pins 40, and in the illustrated exemplified embodiment, all 6 receiving positions are fitted with workpieces 26.

The sensing probe 18 is brought towards the workpiece 26 from the side, i.e. along the y-axis illustrated in FIGS. 7A, 7B and 7C, until it contacts it, while at the same time the deflection of the sensing element 30 is detected until the measured deflection exceeds a certain threshold value. In this case, the sensing probe 18 outputs a signal via the connection cable 17 to the evaluation device 32 that the proximity to be detected has been reached. In this exemplified embodiment, it is possible by means of the movability in 5 spatial directions to measure all dimensions of the workpiece 26 very easily in a single step.

It is also possible to bring the workpiece 26 and the workpiece holder 24 towards the sensing probe 18 along the z-axis illustrated in FIGS. 7A, 7B and 7C while at the same time the deflection of the sensing element 30 is detected. In this exemplified embodiment, when the measured deflection exceeds a certain threshold value, a signal is output via the connection cable 17 to the evaluation device 32 that the proximity to be detected has been reached.

In one or more embodiments, the control device can be configured as a microcontroller/Programmable Logic Controller (PLC), a Proportional-Integral-Derivative (PID) controller, and so forth.

The control device can include a processor, a memory, and a communications interface. The processor provides processing functionality for the control device and can include any number of processors, micro-controllers, or other processing systems, and resident or external memory for storing data and other information accessed or generated by the control device. The processor can execute one or more software programs that implement techniques described herein. The processor is not limited by the materials from which it is formed, or the processing mechanisms employed therein and, as such, can be implemented via semiconductor(s) and/or transistors (e.g., using electronic integrated circuit (IC) components), and so forth.

In the case of a software implementation, the module, functionality, or logic represents program code that performs specified tasks when executed on a processor (e.g., central processing unit (CPU) or CPUs). The program code can be stored in one or more computer-readable memory devices (e.g., internal memory and/or one or more tangible media), and so on. The structures, functions, approaches, and techniques described herein can be implemented on a variety of commercial computing platforms having a variety of processors.

The memory is an example of tangible, computer-readable storage medium that provides storage functionality to store various data associated with operation of the control device, such as software programs and/or code segments, or other data to instruct the processor, and possibly other components of the control device, to perform the functionality described herein. Thus, the memory can store data, such as a program of instructions for operating the system (including its components), and so forth. In embodiments of the disclosure, the memory can be integral with the processor, can comprise stand-alone memory, or can be a combination of both.

The memory can include, but is not necessarily limited to: removable and non-removable memory components, such as random-access memory (RAM), read-only memory (ROM), flash memory (e.g., a secure digital (SD) memory card, a mini-SD memory card, and/or a micro-SD memory card), magnetic memory, optical memory, universal serial bus (USB) memory devices, hard disk memory, external memory, and so forth. In implementations, the cable 100 and/or the memory 154 can include removable integrated circuit card (ICC) memory, such as memory provided by a subscriber identity module (SIM) card, a universal subscriber identity module (USIM) card, a universal integrated circuit card (UICC), and so on.

A communications interface can be operatively configured to communicate with components of the system. It should be noted that while the communications interface is described as a component of a control device, one or more components of the communications interface can be implemented as external components communicatively coupled to the system via a wired and/or wireless connection. The system can also comprise and/or connect to one or more input/output (I/O) devices, including, but not necessarily limited to: a display, a mouse, a touchpad, a keyboard, and so on.

1. A milling machine comprising
a milling spindle.
a workpiece holder which is mounted so as to move with respect to the milling spindle in at least 2 spatial directions,
a workpiece which is held in a clamped manner on the workpiece holder,
a sensor, relative to which the workpiece can be brought into contact and relative to which workpiece the sensor can be moved to sense the workpiece,
wherein the sensor comprises a sensing probe and a sensing element configured to deflect and detect the deflection of the sensing element in at least 1 spatial direction.

2. The milling machine as claimed in claim 1,
wherein the at least 1 spatial direction comprises at least 2, 3 or more spatial directions.

3. The milling machine as claimed in claim 1,
wherein the sensing probe, instead of a tool, is held by clamping in the milling spindle.

4. The milling machine as claimed in claim 1,
wherein the milling machine is a multi-axis milling machine having 5 movement axes of the workpiece holder and no movement axis of the milling spindle, or 5 movement axes of the milling spindle and no movement axis of the workpiece holder, or any other distribution of the movement axes, and
wherein the workpiece is movable on a robot arm towards the sensing probe clamped into the milling spindle.

5. The milling machine as claimed in claim 1,
wherein the workpiece comprises at least one planar surface, and
wherein the workpiece is brought into contact with the sensing probe with the at least one planar surface or a boundary edge of the surface.

6. The milling machine as claimed in claim 1,
wherein the sensing probe is connected to an evaluation device which, upon contact of the sensing probe on the workpiece and upon deflection of the sensing element caused by the contact, the evaluation device outputs a signal which represents a zero point or a zero axis in a milling coordinate system.

7. The milling machine as claimed in claim 1,
wherein the contact is initial contact, and
wherein the workpiece comprises a blank.

8. The milling machine as claimed in claim 1,
wherein the workpiece holder holds a plurality of blanks clamped in the workpiece holder, and
a respective signal is output upon initial contact on each blank, separately for each blank, which respective signal is fed to an evaluation device.

9. The milling machine as claimed in claim 1,
wherein the workpiece comprises an aperture and from each workpiece a dental restoration part with an aperture is produced.

10. A method for operating a milling machine which comprises a milling spindle and a workpiece holder, which workpiece holder is moved with respect to the milling spindle of the milling machine in at least 3 spatial directions, wherein a workpiece is held by clamping the workpiece to the workpiece holder, and having a sensor which is clamped into the milling spindle and is configured to be brought into contact with the workpiece, wherein the workpiece (26) can move relative to the sensing of the workpiece (26),
wherein a sensing element of the sensor designed as a sensing probe is deflected upon contact on the workpiece in at least 2 spatial directions,
wherein a first spatial direction of the at least 2 spatial directions corresponds to the orientation of the sensing element, and a second spatial direction of the at least 2 spatial directions is a direction transverse to orientation of the sensing element.

11. The method as claimed in claim 10,
wherein the sensing element has a tip which is pressed against the workpiece, and the deflection of the sensing element is caused by the pressure, and
wherein the deflection of the sensing element is detected separately for each spatial direction.

12. The method as claimed in claim 10,
wherein the workpiece is formed as a block and comprises at least 2 surfaces which extend perpendicularly to each other and
wherein the sensing probe is brought into contact with the at least 2 surfaces, first one and then the other.

13. The method as claimed in claim 10,
wherein the workpiece comprises at least one planar or partially planar surface, and
wherein the sensing probe is brought into contact with the at least one planar or partially planar surface, and the position of the at least one planar or partially planar surface is detected by the sensing probe at 3 mutually spaced-apart points.

14. The method as claimed in claim 10,
wherein the sensing probe touches an aperture or enters, or partially enters, the aperture and, upon lateral initial contact of the sensing element on the aperture and detected deflection, feeds a zero point signal to an evaluation device, and/or
wherein the workpiece comprises an aperture which extends in a planar surface, and
wherein the sensing probe is at least partially introduced into the aperture to detect the position thereof.

15. The method as claimed in claim 10,
wherein a side surface of a blank is approached by the sensing probe before or after the aperture, and
wherein the contact of the sensing probe on the side surface and the aperture extending therein takes place in one stroke, without breaking the contact between the sensing probe and the blank, and/or
wherein the sensing probe is guided with the sensing element in a sliding manner along the blank.

16. The method as claimed in claim 10,
wherein the aperture comprises a rotation-prevention element, and
wherein the sensing probe enters the aperture and by contact thereon detects the rotation-prevention element.

17. The method as claimed in claim 10,
wherein the second spatial direction is orthogonal to the first spatial direction.

18. A combination of a milling machine and at least one workpiece comprising
a milling spindle and
a workpiece holder which is mounted so as to move with respect to the milling spindle in at least 3 spatial directions,
a workpiece held by the workpiece holder by clamping to the workpiece holder,
a sensor, relative to which the workpiece is brought into contact and relative to which workpiece the sensor is moved to sense the workpiece,
wherein the sensor comprises a sensing probe having sensing element, the sensing element deflects and detects the deflection in at least 1 spatial direction.

19. The combination of claim 18,
wherein the at least 1 spatial direction comprises at least 2 spatial directions.

20. The combination of claim 18,
the workpiece holder moves with respect to the milling spindle in at least 4 spatial directions.
